(19) United States
(12) Patent Application Publication
(10) Pub. No.: US 2023/0331365 A1
(43) Pub. Date: Oct. 19, 2023

(54) ENERGY STORAGE SYSTEM OF A WATERCRAFT

(71) Applicant: SKF MARINE GMBH, Hamburg (DE)

(72) Inventors: Dirk BARGENDE, Elmshorn (DE); Joerg GRABBEL, Hamburg (DE); Sascha KORTEMEIER, Hamburg (DE)

(21) Appl. No.: 18/025,101

(22) PCT Filed: Sep. 13, 2021
(86) PCT No.: PCT/EP2021/075068

§ 371 Date: Mar. 8, 2023

(30) Foreign Application Priority Data
Sep. 14, 2020 (DE) 10 2020 211 491.9

(51) Int. Cl. B63J 3/04; H02J 15/00; H01M 10/42

(52) U.S. Cl. CPC B63J 3/04; H02J 15/007; H01M 10/4264; H01M 2220/20

(57) ABSTRACT

An energy storage system is for at least one electrical consumer in an electrical system of a watercraft. The at least one consumer is preferably a stabilizing device of the watercraft or a steering system for influencing the course of the watercraft. The energy storage system includes at least one converter connected to the electrical system for the supplying of the consumer. An energy storage is associated with the at least one converter.

The invention relates to an energy storage system for at least one electrical consumer in an electrical system of a watercraft, in which the energy storage system includes at least one converter connected to the electrical system, for the supplying of the consumer.

From the prior art, fin stabilizers and steering gears for passenger ships, larger yachts, floating pontoons, and the like are known in a wide range of variation. Fin stabilizers and steering gears work cyclically, wherein temporarily high peak loads can occur due to rapid movement sequences which are often followed by rest or standby phases with a minimal energy intake. The high peak loads in many cases make necessary an over-dimensioned design of the power train of the fin stabilizers, the steering gears, and the electrical systems supplying these consumers.

Fin stabilizers and steering gears are usually operated electrohydraulically. In the case of an electrohydraulic power train, a storage of energy is only possible when a hydrostatic transmission is used as a so-called open hydraulic circuit with nitrogen storage support. A main disadvantage of this storage technology is the comparatively low efficiency of an open hydraulic circuit, since energy not needed here is dissipated in heat in the form of a resistance control. In comparison, both for speed-controlled and displacement-controlled systems, a closed hydraulic circuit has a high degree of efficiency, but owing to the principles involved cannot use hydraulic storage.

An object of the invention is therefore to specify an energy storage system for an electrical system of a watercraft such as a ship such that consumers causing high electrical peak loads are operable without an impairment of the stability of the electrical system.

The above-mentioned object is achieved by an energy storage being associated with the at least one converter. The energy storage allows a virtually instantaneous retrieval of electrical energy needed for the maximum load operation of the consumer, with the simultaneous option of recharging the storage unit in standby phases or rest phases of the consumer in which the consumer barely loads the electrical system of the watercraft or does not load it at all. In addition, the storage capacity of the energy storage can be dimensioned large enough that even in the case of a complete electrical system failure (so-called “black ship”), an emergency functionality of the connected electrical consumer is still ensured for at least a minimum period of a plurality of minutes. Thus, for example, a fin of a stabilization device can move into a rest position and still be mechanically locked. Furthermore, the steering position of a rudder, driven by a steering gear, of the watercraft can be moved to a neutral position, or the rudder can be once more “engaged.” The converter can be embodied both in block and in resolved construction.

The energy storage is preferably connected to a DC intermediate circuit of the converter. A simple, in terms of control technology, connecting of the energy storage is thus given.

In one technically advantageous design, the energy storage includes at least one energy converter, and at least one storage unit associated therewith. A modular and easily scalable structure of the energy storage system is thus given. The energy converter is preferably configured to make possible a bidirectional energy flow. As a result, a reversal of the energy flow is possible, or a low-loss energetic recovery of excess electrical energy into the electrical system of the watercraft is realizable.

In the case of a technically favorable further development, the at least one storage unit is formed with at least one high-capacitance capacitor. A high energy density of the storage unit is thereby achieved with a low maintenance intensity. In addition, capacitors have a high cycle stability, low response times, and a long service life. For example, so-called ultracaps, or supercaps, or double-layer capacitors are considered as high-capacitance capacitors. Alternatively or additionally, coils with a highest-possible inductance can also be used.

In one advantageous design, it is provided that the at least one storage unit is formed with at least one centrifugal mass system, in particular a flywheel or the like. Such storage units with a centrifugal mass system achieve short response times, in the short term have only a negligible self-discharge, and are insensitive to repeated deep discharges. In addition, a high energy density is realizable with centrifugal mass systems, for example, in the form of a flywheel with a high net mass rotating with a high rotational speed of up to 100,000 revolutions per minute. In addition, due to gyroscopic effects, a stabilization effect of a ship thus equipped can optionally be achieved at the same time.

The at least one consumer is preferably an electrical consumer causing high peak loads, such as a stabilization device of the watercraft or a steering system for influencing the course of the watercraft. Large electrical consumers of a watercraft that cause high, solitary peak loads can thereby be decoupled from the electrical system.

The watercraft is preferably a ship. The invention is thereby usable in the most frequently encountered type of watercraft with a compact, elongated hull. Alternatively, the watercraft can also be a floating platform, a pontoon, an arrangement of pontoons, or the like.

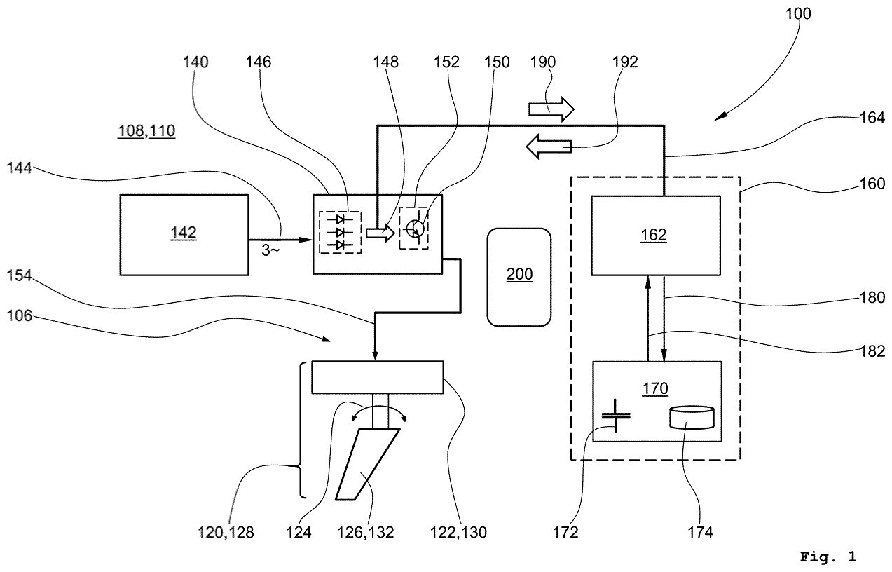

In the following a preferred exemplary embodiment of the invention is explained in more detail with reference to schematic FIGURES. The sole FIG. 1 shows a schematic block circuit image of an inventive energy storage system for a watercraft.

FIG. 1 illustrates a schematic block circuit diagram of an inventive energy storage system for a watercraft such as a ship. An energy storage system 100 serves, by way of example, for supplying a (large) consumer 106, causing high electrical peak loads of a watercraft 108, such as a ship 110 or the like. The electrical consumer 106 is embodied here, merely by way of example, as a stabilizing device 120 with at least one associated electrical drive unit 122 for the—as indicated by a black double arrow 124—swiveling drive of a stabilizing fin 126 for stabilizing the ship 110, not further depicted graphically, about at least one spatial axis. Furthermore, the electrical consumer 106 can also be configured as a steering system 128 with at least one steering gear 130 for driving at least one associated rudder 132 for influencing the course of the ship 110.

The energy storage system 100 comprises, among other things, a converter 140 that is supplied from the electrical system 142 of the ship 110. The electrical system 142 is preferably a three-phase power supply system with a neutral conductor and a protective conductor or ground. Here the converter 140 is constructed, merely by way of example, as a classical conductor with a passive diode bridge 146 for rectifying the three-phase current 144 supplied by the electrical system 142, a DC intermediate circuit 148 for stabilization, and an output inverter 152. The output inverter 152 can be realized with a plurality of circuit breakers, of which here only one circuit breaker 150 is depicted, representative for all other circuit breakers. Output inverter 152 running. The circuit breakers can be, for example, power bipolar transistors, power MOSFETs, IGBTs, thyristors, Triacs, etc. Via a supply line 154, the converter 140 feeds the (large) electrical consumer 106 with the electrical energy required by the operation. The detailed technical circuit structure of the converter is sufficiently familiar to a person skilled in the art active in the field of electrical energy technology so that at this point a detailed explanation can be omitted for the sake of brevity and conciseness of the description. Instead of three-phase current 144, the electrical system 142 can also provide direct current so that instead of the (frequency) converter 140, a not-depicted voltage converter or a so-called DC-DC converter is required.

The energy storage system 100 furthermore comprises an energy storage 160. Here the energy storage 160 includes an energy converter 162 that is electrically connected to the converter 140 by a connecting line 164. In addition, the energy storage 160 includes at least one associated storage unit 170 for storing different forms of energy, such as electrical energy, kinetic energy, chemical energy, or potential energy. The energy storage 160 is preferably intended for the low-loss storing of electrical energy.

The storage unit 170 not depicted in more detail can be, for example, a plurality of high-capacitance (single) capacitors that are interconnected with a capacitor battery. Of the individual capacitors of the capacitor battery, only one capacitor, representative for all others, is indicated with the reference number 172.

In order to make possible a loss-free energy recovery of the energy stored in the storage unit 170 into the DC intermediate circuit 148 of the converter 140, the energy converter 162 is configured to realize a bidirectional energy flow. For this purpose, for example, the energy converter 162 can include at least one electrical converter or one inverter not graphically depicted. If capacitors 172 are used for the storing of electrical energy in the storage unit 170, the energy converter 162 is preferably realized with a DC/DC converter. In contrast, if a centrifugal mass storage or the flywheel 174 is used inside the storage unit 170, the energy converter 162 is constructed with an inverter. These circuit variants of the energy converter 162 allow the above-mentioned bidirectional electrical energy flow.

In contrast to a passive diode bridge, an active front end module makes possible a low-loss bidirectional flow of electrical energy inside the electrical converter in four-quadrant operation, and can be realized, for example, with actively switchable electronic switches, such as, for example, IGBTs, power bipolar transistors, or power MOSFETs. A heating resistor for dissipating the back-flowing electrical energy, as is still absolutely essential in electrical converters or inverters with a diode bridge, is omitted. For this purpose, the controlling of an active front end module is comparatively complex. If an energy recovery is to be possible from the inverter 140 into the electrical system 142, the diode bridge 146 in the inverter 140 must also be replaced by such an active front end module. The detailed structure of such a converter with an active front end module is sufficiently familiar to a person skilled in the art active in the field of energy electronics so that at this point a detailed explanation of the technical circuit details can be omitted for the sake of brevity of the description.

Alternatively or additionally, the storage unit 170 can include at least one centrifugal mass system, such as, for example, a flywheel 174 rotating at high rotational speed. In addition, the storage unit 170 can include chemical batteries with a highest possible energy density, such as, for example, lithium batteries or lithium polymer batteries. Optionally the energy converter 162 can additionally or alternatively include at least one electrolysis cell and at least one fuel cell for the conversion of electrical energy into chemical energy and vice versa. In this case, the storage unit 170 can be configured with a low-pressure metal hydride storage or with a pressure storage for hydrogen under higher pressure, in order to be able to permanently store at least the hydrogen released from the electrolysis cell.

With the aid of the energy converter 162, energy can be supplied to the storage unit 170 of the energy storage 160, which energy can be obtained by converting the electrical energy that can be tapped at the DC intermediate circuit 148 via the connection line 164 into a form of energy suited for the storage unit 170. Conversely, energy can be drawn from the storage unit 170 and supplied again to the DC intermediate circuit 148 of the converter 140 via the connection line 164 in the form of electrical energy by reverse conversion by the energy converter 162. This bidirectional process is illustrated with a charging arrow 180 and a discharging arrow 182 directed opposing it. The charging of the storage unit 170 with an energy form suited for it is generally effected until a complete charging of the storage unit 170 is achieved.

For example, if the storing of energy inside the storage unit 170 is effected with the aid of the flywheel 174, the kinetic energy stored therein can be converted back into electrical energy again with the aid of the energy converter 162 and supplied again via the connection line 164 to the DC intermediate circuit 148 of the converter 140. This can be effected, for example, with the aid of an electric motor in generator mode or a generator that in such a configuration are preferably each integrated in the energy converter 162 and that are mechanically rotated by the flywheel 174. Conversely, electrical energy from the DC intermediate circuit 148 of the converter 140 can be converted into kinetic energy by the energy converter 162 by the flywheel 174, for example, being rotationally driven with the aid of the electric motor until attaining a prescribed maximum rotational speed of the flywheel 174 is attained.

In contrast, if high-capacitance capacitors are used in the storage unit 170, the energy converter 162 only adjusts the electrical energy supplied or removed with respect to the current strength and/or the voltage level. Furthermore, using the energy converter 162, a modeling of the temporal course of the current and/or of the voltage is possible. Furthermore, if necessary, an AC-DC conversion or vice versa, as well as a DC-DC conversion, is possible using the energy converter 162.

In a normal or idle or standby state of the (large) electrical consumer 106, available, but not currently needed, electrical energy is preferably transferred from the DC intermediate circuit 148 via the connection line 164 into the energy storage 160 or stored therein, which is illustrated by a storage arrow 190. This storage process is usually continued until a complete charging of the energy storage 170 is attained. In addition, released braking energy of the (large) electrical consumer 106 can be stored in the energy storage 160 (recuperation).

In contrast, if the electrical consumer 106 causes a peak electrical load or a high continuous load in the DC intermediate circuit 148 that is not completely or temporarily coverable by the electrical system 142, energy storage device 160 and connecting line 164 are used to immediately feed back the missing electrical energy into the DC voltage intermediate circuit 148 of the converter 140 of the energy storage system 100, which is represented by a return storage arrow 192. Depending on the capacity of the storage unit 170 of the energy storage 160, this process can last up to a plurality of minutes. As a result, short-term and also longer-term electrical overload states caused by the (large) electrical consumer 106 in the region of the DC intermediate circuit 148 can be compensated for with the aid of the energy storage 160.

Due to the inventive energy storage system 100, it is furthermore no longer necessary to design the electrical system 142 of the watercraft 108 based on possibly only rarely occurring maximum electrical load peaks of the electrical consumer 106.

Furthermore, in the event of a total failure of the electrical system 142 (“black ship”), at least an emergency operation of the electrical consumer 106 is possible. For example, with the aid of the electrical drive unit 122, that in this configuration is supplied with emergency power by the energy storage 160, the fin 126 of the stabilization device 120 can be moved into a rest position and optionally mechanically locked. The same applies to the electrical steering gear 130 of the steering system 128 for the driving of the rudder 132.

All processes within the energy storage system 100, in particular the storing and recovery of electrical energy into or out of the storage unit 160 via the energy converter 162, and the charging and the discharging of the storage unit 170 of the energy storage 160 with different forms of energy, in particular in the form of electrical energy, kinetic energy, potential energy and/or chemical energy with the aid of the energy converter 162, are controlled by an efficient control and regulating unit 200.

The invention relates to an energy storage system 100 for at least one electrical consumer 106 in an electrical system 142 of a watercraft 108 in which the energy storage system 100 includes at least one converter 140 connected to the electrical system 142 for the supplying of the consumer 106. According to the invention, an energy storage 160 is associated with the at least one converter 140. Even consumers 106 causing high electrical peak loads, such as a stabilization device 120, a steering system 128, or the like, can thereby be operated without problem on an electrical system 142 of a watercraft 108.

### REFERENCE NUMBER LIST

100 Energy storage system
106 Electrical consumer
108 Watercraft
110 Ship
120 Stabilizing device
122 Electrical drive unit
124 Black double arrow
126 Stabilizing fin
128 Steering system
130 Electrical steering gear
132 Rudder
140 Converter
142 Electrical system
144 Three-phase current
146 Diode bridge
148 DC intermediate circuit
150 Circuit breaker
152 Output inverter
154 Supply line
160 Energy storage
162 Energy converter
164 Connection line
170 Storage unit
172 Capacitor
174 Flywheel
180 Charging arrow
182 Discharging arrow
190 Storage arrow
192 Recuperation arrow
200 Control- and/or regulating-unit

1. An energy storage system for at least one electrical consumer in an electrical system of a watercraft, the energy storage system comprising:
at least one converter connected to the electrical system for the supplying of the consumer, and
an energy storage is associated with the at least one converter,
wherein the at least one consumer is a stabilizing device of the watercraft or a steering system for influencing the course of the watercraft.

2. The energy storage system according to claim 1, wherein the energy storage is connected to a DC intermediate circuit of the converter.

3. The energy storage system according to claim 1, wherein the energy storage includes at least one energy converter and at least one storage unit associated with the energy converter.

4. The energy storage system according to claim 3, wherein the energy converter is configured to provide a bidirectional energy flow.

5. The energy storage system according to claim 4, wherein the at least one storage unit includes at least one high-capacitance capacitor.

6. The energy storage system according to claim 4, wherein the at least one storage unit includes at least one centrifugal mass system.

7. (canceled)

8. The energy storage system according to claim 1, wherein the watercraft is a ship.

9. The energy storage system according to claim 6, wherein the at least one centrifugal mass system includes a flywheel.

10. An energy system for an electrical system of a watercraft, the energy system comprising:
at least one electrical consumer,
at least one converter connected to the electrical system for the supplying of the consumer, and
an energy storage associated with the at least one converter,
wherein the at least one consumer is a stabilizing device of the watercraft or a steering system for influencing the course of the watercraft.

11. The energy system according to claim 10, wherein the energy storage is connected to a DC intermediate circuit of the converter.

12. The energy system according to claim 10, wherein the energy storage includes at least one energy converter and at least one storage unit associated with the energy converter of the energy storage.

13. The energy system according to claim 12, wherein the energy converter of the energy storage is configured to provide a bidirectional energy flow.

14. The energy system according to claim 13, wherein the at least one storage unit of the energy storage includes at least one high-capacitance capacitor.

15. The energy system according to claim 13, wherein the at least one storage unit of the energy storage includes at least one centrifugal mass system.

16. The energy system according to claim 15, wherein the at least one centrifugal mass system includes a flywheel.

17. The energy system according to claim 10, wherein the watercraft is a ship.
